(19) United States
(12) Patent Application Publication
(10) Pub. No.: US 2025/0332932 A1
(43) Pub. Date: Oct. 30, 2025

(54) CHARGING INLET ASSEMBLY OF A VEHICLE

(71) Applicant: TE Connectivity Solutions GmbH, Schaffhausen (CH)

(72) Inventors: Ram Kishore Venkatesan, Winston Salem, NC (US); Kevin John Peterson, Kernersville, NC (US); Aaron James de Chazal, Rochester, MI (US); Nathan Philip Myer, Lancaster, PA (US)

(21) Appl. No.: 18/645,854

(22) Filed: Apr. 25, 2024

(51) Int. Cl. B60L 53/16

(52) U.S. Cl. CPC B60L 53/16

(57) ABSTRACT

A charging inlet assembly for an electric vehicle includes a charging inlet housing having terminal channels holding charging terminals. The charging inlet assembly includes a control module at the rear of the charging inlet housing. The control module includes a circuit board assembly received in the rear chamber. The circuit board assembly includes a fixed portion and a flexible portion movable relative to the fixed portion. The fixed portion is fixed relative to the charging inlet housing. The flexible portion is movable relative to the charging inlet housing. The flexible portion includes temperature sensors configured to be thermally coupled to the charging terminals. The temperature sensors are movable relative to the charging terminals with the flexible portion.

### BACKGROUND OF THE INVENTION

The subject matter herein relates generally to vehicle charging systems.

Electric vehicles (EV) and hybrid electric vehicles (HEV) include battery systems for operating the vehicles. The battery systems are charged by a vehicle charging system. For example, a charging connector, which is coupled to a power source, is connected to a charging inlet assembly of the vehicle to charge the battery. The charging inlet assembly includes charging terminals configured to be coupled to the charging connector. There is a need to monitor the temperature of the charging terminals during the charging process to avoid damaging the components of the charging inlet assembly. Typically, the charging inlet assembly includes a temperature sensor for monitoring the temperatures of the charging terminals. However, performance of the temperature sensor is negatively affected by thermal resistance between the temperature sensor and the charging terminal. For example, thermal resistance may occur by insufficient thermal connection between the temperature sensor and the charging terminal, such as from mounting the temperature sensor to a circuit board too remote from the charging terminal. Additionally, the circuit board and the temperature sensors increase the overall cost of the charging inlet assembly.

A need remains for reliable and cost-effective vehicle charging systems for electric vehicles.

### BRIEF DESCRIPTION OF THE INVENTION

In one embodiment, a charging inlet assembly for an electric vehicle is provided and includes a charging inlet housing that has a front and a rear. The charging inlet housing has terminal channels between the front and the rear. The charging inlet housing has a rear chamber at the rear. The charging inlet assembly includes charging terminals received in the corresponding terminal channels and held in the charging inlet housing. The charging terminals have pins configured to be connected to a charging plug. The charging inlet assembly includes a control module at the rear of the charging inlet housing. The control module includes a circuit board assembly received in the rear chamber. The circuit board assembly includes a fixed portion and a flexible portion movable relative to the fixed portion. The fixed portion is fixed relative to the charging inlet housing. The flexible portion is movable relative to the charging inlet housing. The flexible portion includes temperature sensors configured to be thermally coupled to the charging terminals. The temperature sensors are movable relative to the charging terminals with the flexible portion.

In another embodiment, a charging inlet assembly for an electric vehicle is provided and includes a charging inlet housing that has a front and a rear. The charging inlet housing has terminal channels between the front and the rear. The charging inlet housing has a rear chamber at the rear. The charging inlet assembly includes charging terminals received in the corresponding terminal channels and held in the charging inlet housing. The charging terminals have pins configured to be connected to a charging plug. The charging inlet assembly includes a control module at the rear of the charging inlet housing. The control module includes a circuit board assembly received in the rear chamber. The circuit board assembly includes a fixed portion and a flexible portion movable relative to the fixed portion. The fixed portion includes a fixed portion substrate and at least one control component mounted to the fixed portion substrate. The fixed portion substrate is coupled to the charging inlet housing and is fixed relative to the charging inlet housing. The flexible portion includes a flexible portion substrate and at least one control component mounted to the flexible portion substrate. The flexible portion includes at least one flexible element between the fixed portion substrate and the flexible portion substrate to allow the flexible portion substrate to move relative to the fixed portion substrate. The flexible portion includes temperature sensors configured to be thermally coupled to the charging terminals. The temperature sensors are movable relative to the charging terminals with the flexible portion.

In a further embodiment, a charging inlet assembly for an electric vehicle is provided and includes a charging inlet housing that has a front and a rear. The charging inlet housing has terminal channels between the front and the rear. The charging inlet housing has a rear chamber at the rear. The charging inlet assembly includes charging terminals received in the corresponding terminal channels and held in the charging inlet housing. Each charging terminal has a base and a pin extending from the base configured to be connected to a charging plug. The base has a terminal locking element. The charging inlet assembly includes a control module at the rear of the charging inlet housing. The control module includes a circuit board assembly received in the rear chamber. The circuit board assembly includes a fixed portion and a flexible portion movable relative to the fixed portion. The fixed portion is fixed relative to the charging inlet housing. The flexible portion is movable relative to the charging inlet housing. The flexible portion includes temperature sensors configured to be thermally coupled to the charging terminals. The temperature sensors are movable relative to the charging terminals with the flexible portion. The flexible portion includes terminal position assurance elements configured to engage the corresponding terminal locking elements of the charging terminals to lock the charging terminals in the terminal channels to assure proper positioning of the charging terminals in the terminal channels.

### BRIEF DESCRIPTION OF THE DRAWINGS

FIG. 1 is a front perspective view of a charging inlet assembly in accordance with an exemplary embodiment.

FIG. 2 is a rear perspective view of the charging inlet assembly in accordance with an exemplary embodiment.

FIG. 3 shows the terminal housing, the rear cover, the first and second charging terminals, and the control module, which includes the interface connector in accordance with an exemplary embodiment.

FIG. 4 illustrates a portion of the control module showing the circuit board assembly in accordance with an exemplary embodiment in a pre-stage or unconnected position.

FIG. 5 illustrates a portion of the control module showing the circuit board assembly in accordance with an exemplary embodiment in an actuated or connected position.

FIG. 6 is a side view of a portion of the control module showing the circuit board assembly in accordance with an exemplary embodiment in the pre-stage or unconnected position.

FIG. 7 is a side view of a portion of the control module showing the circuit board assembly in accordance with an exemplary embodiment in the actuated or connected position.

FIG. 8 is a front view of a portion of the control module showing the circuit board assembly in accordance with an exemplary embodiment in the connected position.

FIG. 9 is a side view of a portion of the control module showing the circuit board assembly in accordance with an exemplary embodiment in the connected position.

### DETAILED DESCRIPTION OF THE INVENTION

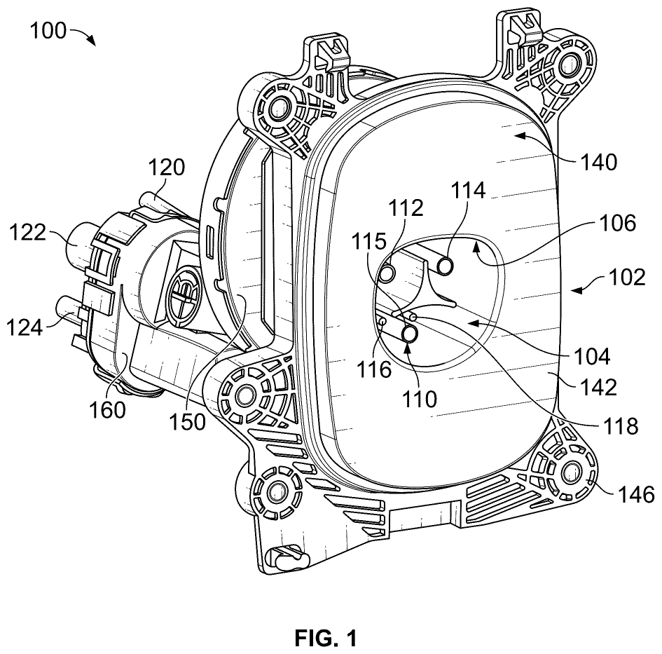

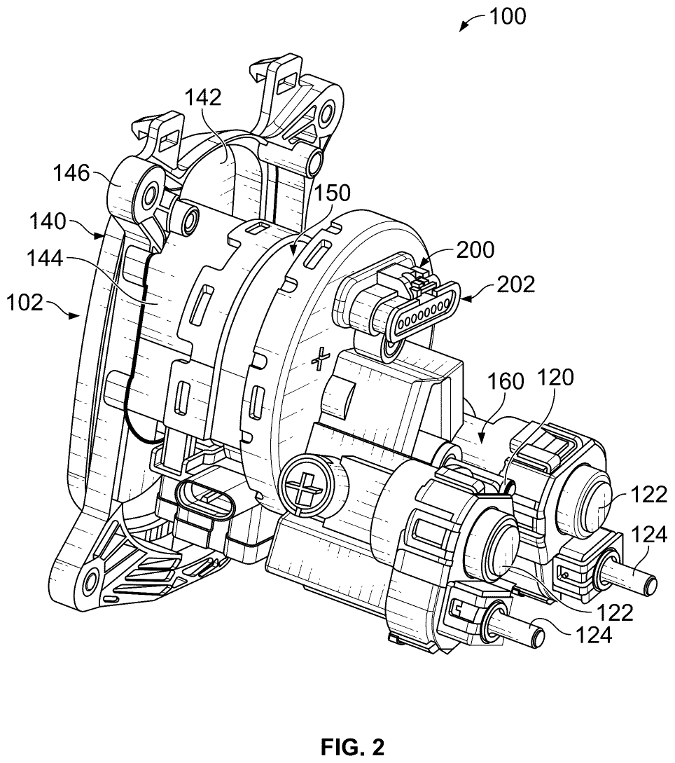

FIG. 1 is a front perspective view of a charging inlet assembly 100 in accordance with an exemplary embodiment. FIG. 2 is a rear perspective view of the charging inlet assembly 100 in accordance with an exemplary embodiment. The charging inlet assembly 100 is configured to be mated with a complimentary charging component (not shown), such as a charging connector or plug charger.

The charging inlet assembly 100 defines a power connector configured to be electrically connected to the plug charger for charging a battery system of a vehicle, such as an electric vehicle (EV) or hybrid electric vehicle (HEV). In an exemplary embodiment, the charging inlet assembly 100 is configured for mating with a North American Charging Standard (NACS) charging plug. For example, the charging inlet assembly 100 has an NACS inlet interface and pinout. Other inlet configurations may be used in alternative embodiments, such as the Type 1 J1772, Combined Charging System Type 1 (CCS1) or Combined Charging System Type 2 (CCS2).

The charging inlet assembly 100 includes a charging inlet housing 102 configured to be mounted in the vehicle. The charging inlet housing 102 forms a portion of the power connector for mating with the charging connector. For example, the charging inlet housing 102 includes a receptacle 104 (FIG. 1) that receives the charging plug. The charging inlet assembly 100 includes a plurality of charging terminals 110 (FIG. 1) for connection to the charging plug. Power cables 120 (FIG. 2) are electrically connected to the charging terminals 110 and routed within the vehicle, such as to the battery.

In an exemplary embodiment, the charging terminals 110 are configured for both AC charging and DC charging. In an exemplary embodiment, the charging terminals 110 include a first power terminal 112, a second power terminal 114, a ground terminal 115, a control pilot terminal 116, and a proximity pilot terminal 118. The first power terminal 112 may be used for positive current (DC+) or split phase AC (Line 1) or single phase AC (Line). The second power terminal 114 may be used for negative DC (DC−) or split phase AC (Line 2) or single phase AC (Neutral). The ground terminal 115 is tied to a full-current protective grounding system. The control pilot terminal 116 is used for charging state/current signaling. The proximity pilot terminal 118 is used for vehicle connector status signaling. The control pilot terminal 116 and the proximity pilot terminal 118 may be connected to a control module 200 configured to control the charging operation, such as ON/OFF, charging rate, current, voltage, and the like.

In an exemplary embodiment, the power cables 120 are electrically connected to corresponding charging terminals 110. The power cables 120 may be routed to other components within the vehicle, such as the battery, an on board charger, a battery control unit, a vehicle control interface module, the vehicle body (for grounding), and the like. In an exemplary embodiment, the power cables 120 may be configured to transmit AC power and/or DC power. For example, AC power may be transmitted to the onboard charger while DC power and/or AC power may be transmitted to the battery for charging the battery. In an exemplary embodiment, the power cables include both DC cables 122 and AC cables 124. The DC cables 122 may transmit high voltage for charging the battery and the AC cables 124 may transmit low voltage for charging the battery or the onboard charger. The DC and AC cables 122, 124 are connected to the corresponding charging terminals 112, 114 within the charging inlet housing 102. The internal connection is made to make cable routing easier.

In an exemplary embodiment, the control module 200 includes an interface connector 202 (FIG. 2). The interface connector 202 may be electrically connected to the ground terminal 115 and/or the control pilot terminal 116 and/or the proximity pilot terminal 118. The interface connector 202 may be connected to other components, such as temperature sensors used to monitor operating temperatures of the charging terminals 112, 114. A connector or wires (not shown) may be electrically connected to the interface connector 202 to connect to another component, such as a battery control unit (not shown) of the battery system. Data is transmitted between the charging inlet assembly 100 and the battery system, such as data relating to the charging operation. For example, the data may relate to charging start/stop, operating temperature of the charging terminals 112, 114, or other charging data. A proximity signal may be sent to the battery system indicating when the charging device is mated to the power connector of the charging inlet assembly 100.

In an exemplary embodiment, the charging inlet housing 102 is a multi-piece housing. For example, the charging inlet housing 102 includes a front housing 140, a terminal housing 150, and a rear cover 160. The housing pieces are assembled together to form the charging inlet housing 102. The front housing 140 forms a charging plug interface 106 at the front of the charging inlet housing 102. The charging plug interface 106 is configured to interface with the charging plug. The front housing 140 is configured to be mounted to the vehicle. The terminal housing 150 holds and surrounds the charging terminals 110. The front housing 140 and/or the terminal housing 150 and/or the rear cover 160 may hold and surround components of the control module 200. For example, a circuit board assembly and corresponding electrical components and temperature sensors may be received in a rear chamber of the terminal housing 150 and held in the terminal housing 150 by the rear cover 160. The interface connector 202 may be provided at the rear of the terminal housing 150 and pass through the rear cover 160 for connection with an electrical connector. The rear cover 160 holds and surrounds the power cables 120.

The front housing 140 includes a front wall 142 and a hub 144 extending from the rear of the front wall 142. The terminal housing 150 is configured to be coupled to the hub 144. For example, the terminal housing 150 may be clipped, latched, secured using fasteners, or secured by other means to the hub 144. The hub 144 surrounds the receptacle 104. In an exemplary embodiment, the front wall 142 includes mounting flanges 146 used to couple the charging inlet assembly 100 to the vehicle. In various embodiments, the mounting flange(s) 146 may be a separate piece(s) coupled to the front wall 142. The front housing 140 may include a seal to seal the charging inlet assembly 100 to the vehicle.

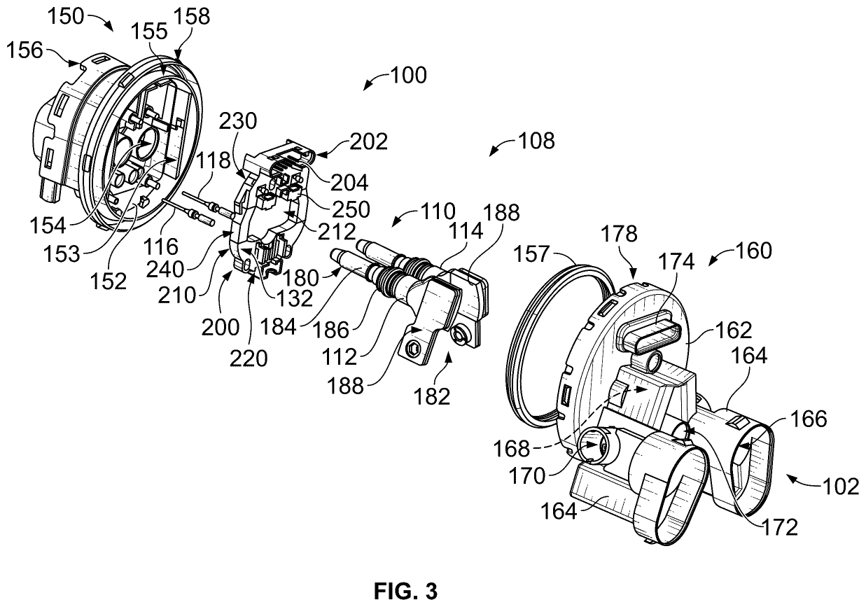

FIG. 3 shows the terminal housing 150, the rear cover 160, the first and second charging terminals 112, 114, and the control module 200, which includes the interface connector 202. The control module 200 and the charging terminals 112, 114 are configured to be received in the terminal housing 150. The rear cover 160 is configured to be coupled to the terminal housing 150 to cover the control module 200 and the charging terminals 112, 114.

The terminal housing 150 includes a base 152 having a plurality of bores therethrough forming terminal channels 154 that receive the corresponding charging terminals 110. The base 152 may be generally circular shaped. However, other shapes are possible in alternative embodiments. The base 152 includes a rear chamber 153 that receives the control module 200. For example, the rear chamber 153 is located at the rear of the base 152. The terminal housing 150 includes a seal pocket 155 at the rear configured to receive an interface seal 157. The seal pocket 155 may extend circumferentially around the terminal housing 150. The interface seal 157 is configured to be sealingly coupled to the terminal housing 150. The interface seal 157 may interface with the rear cover 160 to provide a sealed interface between the terminal housing 150 and the rear cover 160. The terminal housing 150 includes a front mounting bracket 156 at the front of the terminal housing 150 and a rear mounting bracket 158 at the rear of the terminal housing 150. The front mounting bracket 156 is configured to be coupled to the front housing 140 (FIG. 2). The rear mounting bracket 158 is configured to be coupled to the rear cover 160. The mounting brackets 156, 158 may include latches, clips, fasteners, or other securing means to secure the terminal housing 150 to the front housing 140 and the rear cover 160.

The rear cover 160 includes a main wall 162 and cable extensions 164 extending rearward from the main wall 162. The cable extensions 164 include cable channels 166 that receive the corresponding cables. In the illustrated embodiment, the main wall 162 is generally circular in shape. However, other shapes are possible in alternative embodiments. In various embodiments, each cable extension 164 may include a plurality of cable channels 166 that receive corresponding cables. In an exemplary embodiment, the rear cover 160 includes pockets 168 that receive components of the charging inlet assembly 100, such as the charging terminals 110 and/or busbars and/or connectors. The pockets 168 may be open to the cable channels 166. In the illustrated embodiment, the cable extensions 164 are located proximate to a bottom of the rear cover 160. Other locations are possible in alternative embodiments.

In an exemplary embodiment, the rear cover 160 includes openings 170. The openings 170 may receive fasteners, such as bolts used to connect components of the charging inlet assembly 100. In the illustrated embodiment, the openings 170 are provided along sides of the cable extensions 164. Other locations are possible in alternative embodiments. The openings 170 may open to the pockets 168 and/or one or more of the cable channels 166.

In an exemplary embodiment, the rear cover 160 includes a ground terminal channel 172 configured to receive the ground terminal 115 (FIG. 1). The ground terminal channel 172 may be open at the rear to receive the ground terminal 115. In the illustrated embodiment, the ground terminal channel 172 is located between the cable extensions 164. Other locations are possible in alternative embodiments.

In an exemplary embodiment, the rear cover 160 includes a connector shroud 174 at the rear. The connector shroud 174 may surround the interface connector 202. The connector shroud 174 includes a port or slot configured to receive a mating connector configured to mate with the interface connector 202.

In an exemplary embodiment, the rear cover 160 includes a mounting bracket 178 at the front of the rear cover 160. The mounting bracket 178 is configured to interface with the rear mounting bracket 158 of the terminal housing 150 to secure the rear cover 160 to the terminal housing 150. The mounting bracket 178 may include latches, clips, fasteners, or other securing means to secure the mounting bracket 178 to the rear mounting bracket 158.

The control module 200 is configured to be received in the space between the terminal housing 150 and the rear cover 160. For example, the control module 200 may be received in the rear chamber 153 at the rear of the base 152. In an exemplary embodiment, the control module 200 includes a circuit board assembly 210. The interface connector 202 is coupled to the circuit board assembly 210. In an exemplary embodiment, the circuit board assembly 210 is configured to be connected to the charging terminals 110. For example, the circuit board assembly 210 may monitor temperature of the charging terminals 112, 114. The circuit board assembly 210 may receive signals from the control pilot terminal 116 and/or the proximity pilot terminal 118. In various embodiments, the control pilot terminal 116 and the proximity pilot terminal 118 may be mounted to the circuit board assembly 210 and extend to the front of the charging inlet housing 102 for mating with the charging plug. In an exemplary embodiment, the circuit board assembly 210 includes openings 212 that receive the charging terminals 110, such as the charging terminals 112, 114 and/or the ground terminals 115. The openings 212 may be aligned with the terminal channels 154 when the control module 200 is located in the rear chamber 153. The circuit board assembly 210 may include temperature sensors 250 at the openings 212 to sense temperatures of the charging terminals 112, 114 during the charging operation.

In an exemplary embodiment, the circuit board assembly 210 includes various portions. In an exemplary embodiment, the circuit board assembly 210 includes a fixed portion 220 and a flexible portion 230. The flexible portion 230 is movable relative to the fixed portion 220. For example, the flexible portion 230 includes flexible elements 240 connected to the fixed portion 220 that allow the flexible portion 230 to move relative to the fixed portion 220. The fixed portion 220 is configured to be fixed relative to the charging inlet housing 102. For example, the fixed portion 220 is configured to be coupled to the charging inlet housing 102, such as the terminal housing 150. The fixed portion 220 may be secured to the terminal housing 150 using clips, latches, fasteners, epoxy, snap features, an interference fit, or other securing features. The flexible portion 230 is configured to be movable within the rear chamber 153. For example, the flexible portion 230 may be moved into position relative to the charging terminals 112, 114 (for example, moved relative to the fixed portion 220) to thermally couple to the charging terminals 112, 114 and/or for terminal position assurance, such as to lock the charging terminals 112, 114 in the charging inlet housing 102. In an exemplary embodiment, the temperature sensors 250 are associated with the flexible portion 230 and are moveable with the flexible portion 230 relative to the charging terminals 112, 114. The temperature sensors 250 are configured to be thermally coupled to the charging terminals 112, 114 when the flexible portion 230 is moved from a first position to a second position.

In an exemplary embodiment, the control module 200 includes control contacts 204. The control contacts 204 are provided at the interface connector 202, such as for mating with a mating connector. In an exemplary embodiment, one or more of the control contacts 204 may be electrically connected to the control pilot terminal 116 and/or the proximity pilot terminal 118 to transmit signals between the pilot terminals 116, 118 and the interface connector 202. In an exemplary embodiment, one or more of the control contacts 204 may be electrically connected to the temperature sensors 250 used to monitor the temperature of the charging terminals 112, 114. Optionally, one or more of the control contacts 204 may be electrically connected to the ground terminal 115 (FIG. 1). In an exemplary embodiment, the control contacts 204 may be formed as a lead frame that is overmolded by plastic material to form the control module 200. In other embodiments, the control contacts 204 may be stitched or otherwise inserted into a plastic housing or carrier that forms the control module 200. In further embodiments, the control contacts 204 may be terminated to circuits of a printed circuit board of the circuit board assembly 210.

The control module 200 and the interface connector 202 may be communicatively coupled to the other charging component, such as the charging connector or plug, to control the charging activity. The control module 200 may turn on the power supply, turn off the power supply, increase the power supply, and/or decrease the power supply. The charging operation may be controlled based on the control and/or proximity signals from the pilot terminals 116, 118. The charging operation may be controlled based on the operating temperatures of the charging terminals 110. For example, as the temperature increases or approaches an allowable operating temperature, the power supply may be decreased. For example, the voltage or current may be reduced. The charging operation may stop if the operating temperature of the charging terminals 110 is above a threshold temperature.

In an exemplary embodiment, the first and second charging terminals 112, 114 may be similar to each other. For example, the first and second charging terminals 112, 114 may be mirrored versions of each other. The charging terminal 112 extends between a mating end 180 and a terminating end 182. The charging terminal 112 includes a mating pin 184 at the mating end 180. The mating pin 184 is configured to be loaded through the opening 212 in the control module 200 and is configured to be received in the terminal channel 154 of the terminal housing 150. In an exemplary embodiment, the charging terminal 112 includes a terminal seal 186 surrounding the mating pin 184. The terminal seal 186 is configured to be sealed to the terminal housing 150 in the terminal channel 154. In an exemplary embodiment, the charging terminals 112 includes a pad or busbar 188 at the terminating end 182. The busbar 188 is configured to be directly or indirectly connected to the corresponding power cables 120. For example, the terminal busbar 188 may be welded, crimped, or bolted to the power cable 120.

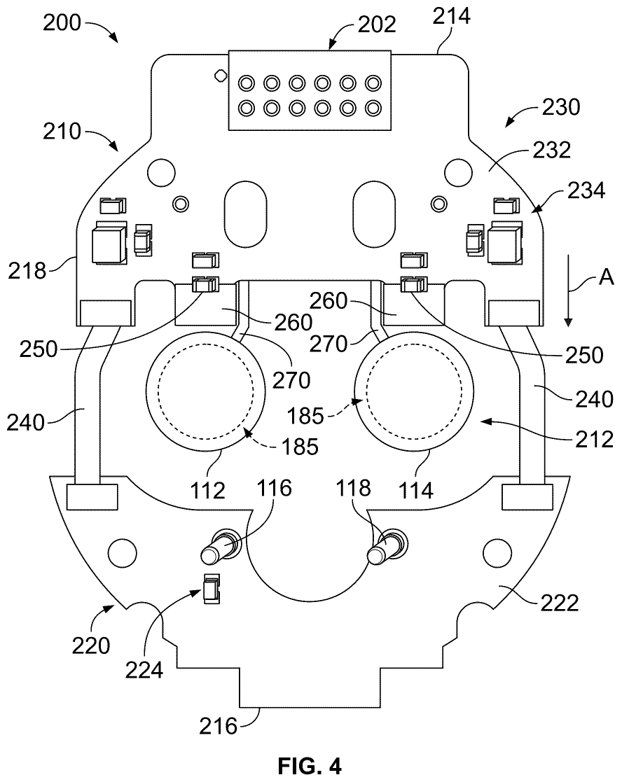

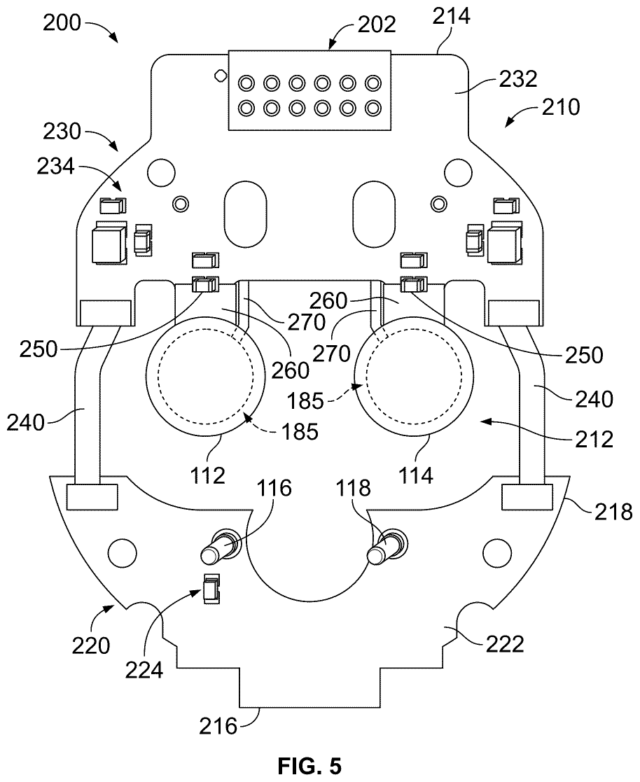

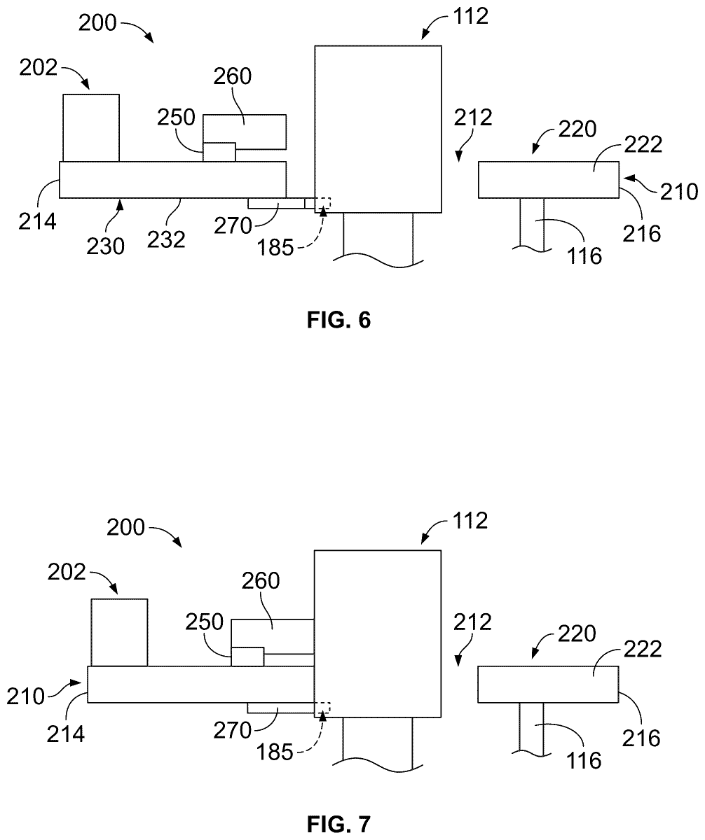

FIG. 4 illustrates a portion of the control module 200 showing the circuit board assembly 210 in accordance with an exemplary embodiment in a pre-stage or unconnected position. FIG. 5 illustrates a portion of the control module 200 showing the circuit board assembly 210 in accordance with an exemplary embodiment in an actuated or connected position. FIG. 6 is a side view of a portion of the control module 200 showing the circuit board assembly 210 in accordance with an exemplary embodiment in the pre-stage or unconnected position. FIG. 7 is a side view of a portion of the control module 200 showing the circuit board assembly 210 in accordance with an exemplary embodiment in the actuated or connected position. The circuit board assembly 210 includes the fixed portion 220 and the flexible portion 230. The flexible element(s) 240 connect the flexible portion 230 to the fixed portion 220. The flexible elements 240 allow the flexible portion 230 to move from the unconnected position (FIGS. 4 and 6) to the connected position (FIGS. 5 and 7).

The circuit board assembly 210 extends between a top 214 and a bottom 216. The circuit board assembly 210 includes sides 218 between the top 214 and the bottom 216. In the illustrated embodiment, the fixed portion 220 is at the bottom 216 and the flexible portion 230 is at the top 214. The opening 212 is located between the fixed portion 220 and the flexible portion 230 to receive the charging terminals 112, 114 between the fixed portion 220 and the flexible portion 230. The flexible element(s) 240 are located at one or both sides 218, such as extending along the side(s) of the opening 212 and along the side(s) of the charging terminals 112, 114. In an exemplary embodiment, the flexible portion 230 is movable in a connecting direction (shown by arrow A) generally toward the fixed portion 220, such as in a downward direction. The flexible portion 230 is configured to move toward the charging terminals 112, 114, such as to interface with the charging terminals 112, 114. The size (for example, height) of the opening 212 may be changed (for example, reduced) when the flexible portion 230 is moved in the connecting direction.

The fixed portion 220 includes a fixed portion substrate 222 and at least one control component 224 mounted to the fixed portion substrate 222. In an exemplary embodiment, the fixed portion substrate 222 includes a rigid circuit board. In alternative embodiments, the fixed portion substrate 222 includes a leadframe, such as an overmolded leadframe. In an exemplary embodiment, the control components 224 include the control pilot terminal 116 and/or the proximity pilot terminal 118. For example, the control pilot terminal 116 and/or the proximity pilot terminal 118 may extend forward from the front surface of the fixed portion substrate 222. The control pilot terminal 116 and/or the proximity pilot terminal 118 may be mounted to the fixed portion substrate 222, such as being soldered to circuits or conductors of the fixed portion substrate 222. The control components 224 may include capacitors, resistors, chips, integrated circuits, microprocessors, memory modules, communication modules, or other types of control components. The flexible elements 240 are electrically connected to the fixed portion substrate 222, such as at the side(s) 218. The flexible elements 240 may be soldered to circuits or conductors of the fixed portion substrate. Data may be transmitted to/from the control components 224 on the flexible elements 240. For example, data from the control pilot terminal 116 and/or the proximity pilot terminal 118 may be transmitted to the flexible portion 230 via the flexible elements 240.

The flexible portion 230 includes a flexible portion substrate 232 and at least one control component 234 mounted to the flexible portion substrate 232. The flexible portion 230 includes the flexible elements 240, which connect the flexible portion substrate 232 and the fixed portion substrate 222. In an exemplary embodiment, the flexible portion substrate 232 includes a rigid circuit board. In alternative embodiments, the flexible portion substrate 232 includes a leadframe, such as an overmolded leadframe. In other alternative embodiments, the flexible portion substrate 232 includes a flexible circuit. The interface connector 202 may be coupled to the flexible portion substrate 232, such as at the top 214.

In an exemplary embodiment, the control components 234 include the temperature sensors 250. For example, the temperature sensors 250 may be coupled to the flexible portion substrate 232, such as to the front or rear surface of the flexible portion substrate 232. The temperature sensors 250 may be located at the opening 212, such as proximate to the charging terminals 112, 114. The temperature sensors 250 may be mounted to the flexible portion substrate 232, such as being soldered to circuits or conductors of the flexible portion substrate 232. The temperature sensors 250 are movable with the flexible portion substrate 232, such as in the connecting direction. The control components 234 may include capacitors, resistors, chips, integrated circuits, microprocessors, memory modules, communication modules, or other types of control components.

The flexible elements 240 are electrically connected to the flexible portion substrate 232, such as at the side(s) 218. In various embodiments, the flexible elements 240 are discrete elements from the flexible portion substrate 232 and are configured to be electrically connected thereto. In alternative embodiments, the flexible elements 240 may be integral with the flexible portion substrate 232, such as being extensions of from the main portion of the flexible portion substrate 232. In an exemplary embodiment, the flexible elements 240 are flexible cables having opposite ends terminated to the fixed and flexible substrates 222, 232. In other embodiments, the flexible elements 240 are flexible printed circuits having opposite ends terminated to the fixed and flexible substrates 222, 232. In alternative embodiments, the flexible elements 240 are wires having opposite ends terminated to the fixed and flexible substrates 222, 232. The flexible elements 240 may be soldered to circuits or conductors of the flexible portion substrate 232. Data may be transmitted to/from the fixed portion 230 on the flexible elements 240. For example, data from the control pilot terminal 116 and/or the proximity pilot terminal 118 may be transmitted to the flexible portion 230 via the flexible elements 240. In the illustrated embodiment, two flexible elements 240 are provided, one at each side 218. However, greater or fewer flexible elements 240 may be used in alternative embodiments, such as a single flexible element 240 at one of the sides 218.

In an exemplary embodiment, thermal pads 260 are provided as thermal interfaces between the charging terminals 112, 114 and the temperature sensors 250. The thermal pads 260 may be mounted to or supported by the flexible portion substrate 232. In an exemplary embodiment, the thermal pads 260 are thermally conductive insulators. For example, the thermal pads 260 are manufactured from a thermally conductive material that is also an electrically insulative material to electrically insulate the temperature sensors 250 from the charging terminals 112, 114. In various embodiments, the thermal pads 260 are manufactured from alumina (Al2O3), alumina nitride (AlN), hexagonal boron nitride (BN), or other thermally conductive and electrically insulative material. The thermal pads 260 may be manufactured from glassfibre supported silicone elastomer with ceramic oxide fillers. The thermal pads 260 may be thermally conductive silicon rubber elements. The thermal pads 260 are movable with the flexible portion substrate 232, such as in the connecting direction. In an exemplary embodiment, the thermal pads 260 are compressible, such as to conform or deform when pressed against the charging terminals 112, 114 to provide an efficient thermal interface with the charging terminals 112, 114.

In an exemplary embodiment, each charging terminal 112, 114 includes a terminal locking element 185. The terminal locking element 185 may be used to lock the charging terminal 112, 114 in the charging inlet assembly 100. In an exemplary embodiment, the terminal locking element 185 includes a protrusion extending from an exterior of the charging terminal 112, 114. For example, the charging terminal 112, 114 may include a flange or flanges defining the terminal locking element 185. The flanges may extend partially or entirely circumferentially around the charging terminal 112, 114. In other various embodiments, the terminal locking element 185 includes a groove or slot formed in the exterior surface of the charging terminal 112, 114. A latch or other type of locking feature is configured to interface with the terminal locking element 185 to secure the charging terminal 112, 114 in the charging inlet assembly 100.

In an exemplary embodiment, the control module 200 includes terminal position assurance (TPA) elements 270 configured to interact with the charging terminals 112, 114 to assure that the charging terminals 112, 114 are properly positioned or seated in the charging inlet housing 102. In an exemplary embodiment, the TPA elements 270 may interface with the terminal locking elements 185 to assure that the charging terminals 112, 114 are properly positioned. For example, the TPA elements 270 are unable to interface with the terminal locking elements 185 unless the charging terminals 112, 114 are properly positioned. In other words, the TPA elements 270 are only able to interface with the terminal locking elements 185 when the charging terminals 112, 114 are properly positioned. In an exemplary embodiment, the TPA elements 270 help to reduce movement of the charging terminals 112, 114 within the charging inlet housing 102. In an exemplary embodiment, the TPA elements 270 extend from the flexible portion substrate 232. The TPA elements 270 extend into the opening 212. In an exemplary embodiment, the TPA elements 270 are latches configured to engage the terminal locking elements 185, such as engaging the flange or being received in the groove. The TPA elements 270 may be located adjacent the temperature sensors 250 and/or the thermal pads 260. The TPA elements 270 may support the temperature sensors 250 and/or the thermal pads 260. The TPA elements 270 are movable with the flexible portion substrate 232, such as in the connecting direction.

During assembly, the circuit board assembly 210 is assembled in the charging inlet housing 102. The fixed portion 220 is secured in the charging inlet housing 102. For example, the fixed portion substrate 222 is coupled to the charging inlet housing 102, such as the terminal housing 150. The charging inlet housing 102 includes support elements, such as walls, locating posts, shoulders, ledges, or other support elements to position and secure the fixed portion 220 in the rear chamber 153. The flexible portion 230 is connected to the fixed portion 220 by the flexible elements 240, which allows the flexible portion 230 to move relative to the fixed portion 220. The opening 212 is formed between the fixed portion 220 and the flexible portion 230. The charging terminals 112, 114 are located in the opening 212. Optionally, the charging terminals 112, 114 may be loaded into the opening 212 after the circuit board assembly 210 is located in the rear chamber 153. Alternatively, the circuit board assembly 210 is loaded into the rear chamber 153 after the charging terminals 112, 114 are located in the charging connector housing 102.

During assembly, the flexible portion 230 is configured to be coupled to the charging terminals 112, 114. For example, the flexible portion 230 may be moved in the connecting direction (arrow A) to connect to the charging terminals 112, 114. When connected, the temperature sensors 250 and the thermal pads 260 are connected to the charging terminals 112, 114 when the flexible portion 230 is moved in the connecting direction. Prior to moving the flexible portion 230 in the connecting direction, the temperature sensors 250 and thermal pads 260 have clearance with the charging terminals 112, 114 to allow assembly of the charging terminals 112, 114 and/or the circuit board assembly 210 into the charging inlet housing 102. When connected, the thermal pads 260 may press against the charging terminals 112, 114 to make an efficient thermal interface between the temperature sensors 250 and the charging terminals 112, 114. When connected the TPA elements 270 are connected to the terminal locking elements 185 when the flexible portion 230 is moved in the connecting direction. Prior to moving the flexible portion 230 in the connecting direction, the TPA elements 270 have clearance with the terminal locking elements 185 of the charging terminals 112, 114 to allow assembly of the charging terminals 112, 114 and/or the circuit board assembly 210 into the charging inlet housing 102.

The circuit board assembly 210 is flexible for at least a section of the circuit board assembly 210 between the top 214 and the bottom 216. For example, the circuit board assembly 210 is flexible at least at the flexible elements 240. The flexible elements 240 span along one or both of the sides 218. The flexible elements 240 may span approximately 20% of the overall height of the circuit board assembly 210. However, the flexible elements 240 may span a greater amount, such as approximately 30% or more of the overall height of the circuit board assembly 210. The flexible elements 240 reduce the overall size of the rigid circuit board(s) of the circuit board assembly 210, which may reduce the overall cost of the circuit board assembly 210. The fixed portion 220 is located below the charging terminals 112, 114 and extends to the bottom 216. The flexible portion 230 is located above the charging terminals 112, 114 and extends to the top 214. The flexible elements 240 of the flexible portion 230 extends along at least one side of the charging terminals 112, 114 to connect to the fixed portion 220 below the charging terminals 112, 114. In an exemplary embodiment, the flexible elements 240 are flexed to allow the flexible portion 230 to move in the connecting direction. The flexible portion 230 is moved toward the fixed portion 220. The flexible portion 230 is moved toward the charging terminals 112, 114.

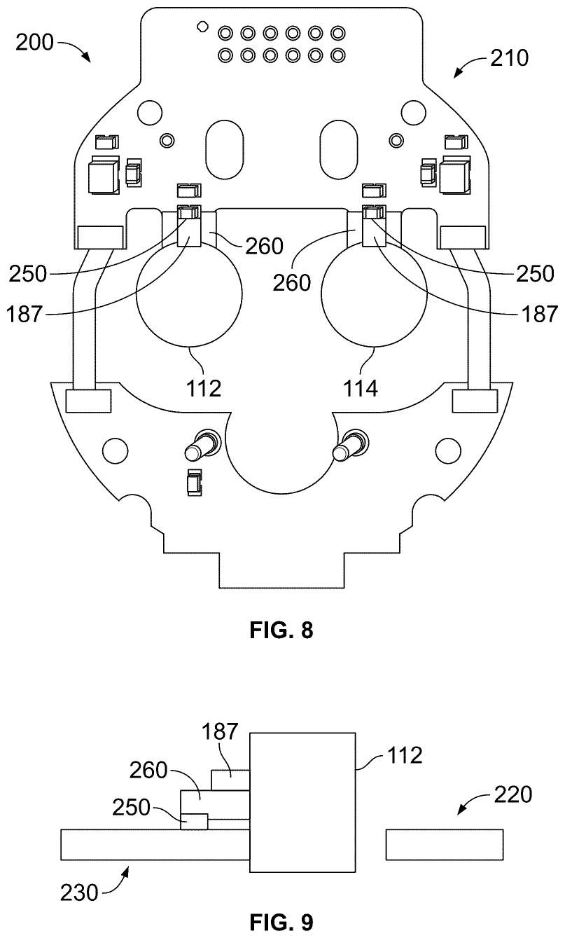

FIG. 8 is a front view of a portion of the control module 200 showing the circuit board assembly 210 in accordance with an exemplary embodiment in the connected position. FIG. 9 is a side view of a portion of the control module 200 showing the circuit board assembly 210 in accordance with an exemplary embodiment in the connected position. In the illustrated embodiment, the charging terminal 112 includes a mounting pad 187. The mounting pad 187 is configured to press against the thermal pad 260 when the charging terminal 112 is plugged into the terminal channel of the charging inlet housing 102. The mounting pad 187 is configured to compress the thermal pad 260 between the mounting pad 187 and the temperature sensor 250, such as to improve the efficiency of the thermal connections.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A charging inlet assembly for an electric vehicle comprising:
a charging inlet housing having a front and a rear, the charging inlet housing having terminal channels between the front and the rear, the charging inlet housing having a rear chamber at the rear;
charging terminals received in the corresponding terminal channels and held in the charging inlet housing, the charging terminals having pins configured to be connected to a charging plug; and
a control module at the rear of the charging inlet housing, the control module including a circuit board assembly received in the rear chamber, the circuit board assembly including a fixed portion and a flexible portion movable relative to the fixed portion, the fixed portion being fixed relative to the charging inlet housing, the flexible portion movable relative to the charging inlet housing, the flexible portion including temperature sensors configured to be thermally coupled to the charging terminals, the temperature sensors movable relative to the charging terminals with the flexible portion.

2. The charging inlet assembly of claim 1, wherein the flexible portion is electrically connected to the fixed portion by a flexible element.

3. The charging inlet assembly of claim 2, wherein the flexible element is one of a flexible cable, a flexible printed circuit, or wires.

4. The charging inlet assembly of claim 1, wherein the fixed portion includes a control pilot terminal and a proximity pilot terminal extending to the front of the charging inlet housing for mating with the charging plug.

5. The charging inlet assembly of claim 1, wherein the fixed portion includes a fixed portion substrate and at least one control component mounted to the fixed portion substrate, the fixed portion substrate being coupled to the charging inlet housing and being fixed relative to the charging inlet housing, the flexible portion including a flexible portion substrate and at least one control component mounted to the flexible portion substrate, the flexible portion including at least one flexible element between the fixed portion substrate and the flexible portion substrate to allow the flexible portion substrate to move relative to the fixed portion substrate.

6. The charging inlet assembly of claim 1, further comprising thermal pads between the temperature sensors and the charging terminals, the thermal pads manufactured from a thermally conductive material and electrically insulating material.

7. The charging inlet assembly of claim 6, wherein the thermal pads are compressible.

8. The charging inlet assembly of claim 6, wherein each charging terminal includes a mounting pad, the mounting pad pressing against the thermal pad when the charging terminal is plugged into the terminal channel of the charging inlet housing.

9. The charging inlet assembly of claim 1, wherein each charging terminal includes a terminal locking element, the flexible portion including terminal position assurance elements configured to engage the corresponding terminal locking elements of the charging terminals to lock the charging terminals in the terminal channels to assure proper positioning of the charging terminals in the terminal channels.

10. The charging inlet assembly of claim 1, wherein the fixed portion includes a stamped and formed lead frame.

11. The charging inlet assembly of claim 1, wherein the flexible portion includes a rigid flexible portion substrate and a flexible element between the flexible portion substrate in the fixed portion.

12. The charging inlet assembly of claim 1, wherein the circuit board assembly extends between a top and a bottom, the circuit board assembly being flexible for at least a section of the circuit board assembly between the top and the bottom.

13. The charging inlet assembly of claim 12, wherein the fixed portion is located below the charging terminals and extends to the bottom, the flexible portion located above the charging terminals and extends to the top, the flexible portion extending along at least one side of the charging terminals to connect to the fixed portion below the charging terminals.

14. The charging inlet assembly of claim 1, wherein the control module includes an interface connector coupled to the circuit board assembly.

15. The charging inlet assembly of claim 1, wherein the charging terminals are arranged for mating with a standard NACS charging plug.

16. The charging inlet assembly of claim 1, wherein the charging inlet housing includes a front housing having a charging plug interface, a terminal housing holding the charging terminals, and a rear cover coupled to the terminal housing, the front housing, the terminal housing and the rear cover being separate and discrete components coupled together to form the charging inlet housing.

17. A charging inlet assembly for an electric vehicle comprising:
a charging inlet housing having a front and a rear, the charging inlet housing having terminal channels between the front and the rear, the charging inlet housing having a rear chamber at the rear;
charging terminals received in the corresponding terminal channels and held in the charging inlet housing, the charging terminals having pins configured to be connected to a charging plug; and
a control module at the rear of the charging inlet housing, the control module including a circuit board assembly received in the rear chamber, the circuit board assembly including a fixed portion and a flexible portion movable relative to the fixed portion, the fixed portion including a fixed portion substrate and at least one control component mounted to the fixed portion substrate, the fixed portion substrate being coupled to the charging inlet housing and being fixed relative to the charging inlet housing, the flexible portion including a flexible portion substrate and at least one control component mounted to the flexible portion substrate, the flexible portion including at least one flexible element between the fixed portion substrate and the flexible portion substrate to allow the flexible portion substrate to move relative to the fixed portion substrate, the flexible portion including temperature sensors configured to be thermally coupled to the charging terminals, the temperature sensors movable relative to the charging terminals with the flexible portion.

18. The charging inlet assembly of claim 17, wherein the flexible element is one of a flexible cable, a flexible printed circuit, or wires.

19. The charging inlet assembly of claim 17, further comprising thermal pads between the temperature sensors and the charging terminals, the thermal pads manufactured from a thermally conductive material and electrically insulating material.

20. The charging inlet assembly of claim 17, wherein each charging terminal includes a terminal locking element, the flexible portion including terminal position assurance elements configured to engage the corresponding terminal locking elements of the charging terminals to lock the charging terminals in the terminal channels to assure proper positioning of the charging terminals in the terminal channels.

21. A charging inlet assembly for an electric vehicle comprising:
a charging inlet housing having a front and a rear, the charging inlet housing having terminal channels between the front and the rear, the charging inlet housing having a rear chamber at the rear;
charging terminals received in the corresponding terminal channels and held in the charging inlet housing, each charging terminal having a base and a pin extending from the base configured to be connected to a charging plug, the base having a terminal locking element; and
a control module at the rear of the charging inlet housing, the control module including a circuit board assembly received in the rear chamber, the circuit board assembly including a fixed portion and a flexible portion movable relative to the fixed portion, the fixed portion being fixed relative to the charging inlet housing, the flexible portion movable relative to the charging inlet housing, the flexible portion including temperature sensors configured to be thermally coupled to the charging terminals, the temperature sensors movable relative to the charging terminals with the flexible portion, the flexible portion including terminal position assurance elements configured to engage the corresponding terminal locking elements of the charging terminals to lock the charging terminals in the terminal channels to assure proper positioning of the charging terminals in the terminal channels.

22. The charging inlet assembly of claim 21, wherein the flexible portion is electrically connected to the fixed portion by a flexible element, the flexible element being one of a flexible cable, a flexible printed circuit, or wires.

23. The charging inlet assembly of claim 21, wherein the fixed portion includes a fixed portion substrate and at least one control component mounted to the fixed portion substrate, the fixed portion substrate being coupled to the charging inlet housing and being fixed relative to the charging inlet housing, the flexible portion including a flexible portion substrate and at least one control component mounted to the flexible portion substrate, the flexible portion including at least one flexible element between the fixed portion substrate and the flexible portion substrate to allow the flexible portion substrate to move relative to the fixed portion substrate.

24. The charging inlet assembly of claim 21, further comprising thermal pads between the temperature sensors and the charging terminals, the thermal pads manufactured from a thermally conductive material and electrically insulating material.
